(19) United States
(12) Patent Application Publication
(10) Pub. No.: US 2026/0026520 A1
(43) Pub. Date: Jan. 29, 2026

(54) LYOPHILIZED-FOOD AND THE PROCESSING METHOD TO MAKE IT

(71) Applicant: QINGDAO ANXIN SEIKA FOOD CO., LTD, Qingdao (CN)

(72) Inventor: Qian CHENG, Tianjin (CN)

(73) Assignee: QINGDAO ANXIN SEIKA FOOD CO., LTD, Qingdao (CN)

(21) Appl. No.: 19/342,797

(22) Filed: Sep. 29, 2025

Related U.S. Application Data
(63) Continuation of application No. PCT/CN2024/085714, filed on Apr. 3, 2024.

(30) Foreign Application Priority Data
Apr. 1, 2024 (CN) 202410385065.6

(51) Int. Cl. A23B 2/92; A23L 2/02; A23L 33/115

(52) U.S. Cl. CPC A23B 2/92; A23L 2/02; A23L 33/115

(57) ABSTRACT

The provided is a lyophilized-food and the processing method to produce it. The lyophilized-food is consists of two parts of the outer part and the inner part, therein, the inner part(s) is/are in individual particles, in one single pieces and/or several pieces together, fully covered and trapped by the outer part, and the inner part(s) is/are fixed inside the outer part of the lyophilized-food. The outer part of the lyophilized-food is in a structure of non-continuous fat phase, and, as the key point of the lyophilized-food, the inner part(s) of the lyophilized-food is/are including at least one of the products in continuous fat phase and/or in a structure of continuous aqueous phase enrobed by continuous fat phase. The lyophilized-food has not only the crispy mouthfeel properties and high thermal stability of no sticking on it packing, no melting and/or deforming under the condition of 70° C. temperature.

### CROSS REFERENCE TO THE RELATED APPLICATIONS

This application is a continuation application of International Application No. PCT/CN2024/085714, filed on Apr. 3, 2024, which is based upon and claims priority to Chinese Patent Application No. 202410385065.6, filed on Apr. 1, 2024, the entire contents of which are incorporated herein by reference.

### TECHNICAL FIELD

The present disclosure invention belongs to the field of food and food processing, more specific, belongs to the lyophilized-food and/or so-called freeze-dried food and a preparation processing method to produce it thereof.

### BACKGROUND

Lyophilized-food or so-called freeze-dried foods, including disclosed freeze-dried chocolate are have the typical properties of crispy mouthfeel and high thermal stabilities, and maximization of nutrition maintaining. However, the existing lyophilized-food or freeze-dried foods including existing freeze-dried chocolate are all having following disadvantages:
They bring uncomfortable drying and powdering mouthfeel to consumer, like eating biscuit and/or dry cookies, while need consumer to secrete more saliva, or even to drink water to balance the drying and powdering mouthfeel during eating.
They, especially the existing freeze-dried chocolate, can not provide consumer the watering and silky smooth mouthfeel like enjoying soft center filled biscuit or cookies, and the normal chocolate with soft center filling.
They, especially the existing freeze-dried chocolate products, do not provide consumer the melt-in-mouth and silky smooth mouthfeel like normal chocolate and chocolate truffles have.

Chinese patent No. CN202211705065.7 disclosed a freeze-dried chocolate including the processing for making it, which freeze-dried chocolate products are made by chocolate powder in a total fat content of ≤25%. However the freeze-dried chocolate by the patent, except getting crispy mouthfeel and high thermal stability than other higher fat content chocolate including other freeze-dried ones, example the one disclosed in European Patent No. EP 1072199 A1, they still have the above mention disadvantages, like drying and powdering mouthfeel, not silky smooth mouthfeel, and they will have residues on consumer's tooth especially when biting the product directly.

European Patent No. EP 1072199 A1 discloses a freeze-dried food product, including a process for preparing freeze-dried food product, namely, by adding oil or fat in preparing a solution or paste, which aims to provide a little better silky smooth taste than other freeze-dried food products. However, product produced by the processing in the patent still has the following problems: it still can not provide watering and silky smooth mouthfeel, and it still have drying and powdering mouthfeel, and the products by the patent are sticking and staining the packaging when putting under a temperature higher than 55° C., so its thermal stability is not as good as the freeze-dried chocolate by Chinese patent No. CN202211705065.7.

Another Chinese patent No. CN202310806854.8 disclosed another freeze-dried chocolate including the processing to make it. Although it claims the chocolate in a fat content higher than Chinese patent No. CN202211705065.7, however, due to its processing method, the products by this patent have no melt-in-mouth mouthfeel and bring more drying and hard mouthfeel like eating baked and extruded foods. And furthermore, it is worth to point out seriously that, the processing of tempering processing step as claimed in claim 2 of this patent is obviously contradictions and unscientific, because, especially after first pre-freeze under a temperature of −40° C.˜−20° C. as described in the patent, the Chinese patent No. CN202310806854.8, it is impossible to proceed chocolate tempering, as claimed in the patent, under temperature of −10° C.˜10° C., according to the well known property of cocoa butter and other fat and oil. It can be seen that the content of the patent is not true to some extent.

### SUMMARY

In view of above, the main objectives of the invention of the present disclosure is to provide a lyophilized-feed, including lyophilized-chocolate, and the processing method to produce it, to overcome the disadvantages from other disclosed freeze-dried products as mentioned above, to provide consumer the watering, silky smooth and melt-in-mouth mouthfeel like eating normal chocolate, and, most important, at the mean while, also to maintain the same even higher thermal stability as Chinese patent No. CN202211705065.7 mentioned and claimed.

The present invention provides a lyophilized-food which product has a structure of: it consists of two parts of the outer part and the inner part, the two parts are all consist of food substance and materials and the products made from them. The inner part of the present invention is/are in individual particles, in one pieces and/or several pieces together, fully covered and trapped by the outer part, and the inner part(s) is/are fixed inside the lyophilized-food by the outer part.

The present invention provides a lyophilized-food and the processing method to produce it, which processing method comprises following processing steps:
a) Making outer part solution: making the outer part solution of the outer part by the processing methods of dissolving, mixing, grinding, emulsifying and/or homogenizing. The outer part solution is in continuous-water phase or continuous aqueous phase, in paste state or in liquid state, with a total water content of 20% to 90% of total weight of the outer part solution.
b) Preparing or making the inner part(s): preparing or making inner part(s) from food substance and material(s), or the products made from them according to the formulation of the lyophilized-food. The inner part is in a ratio of 20%-80% of the lyophilized-food, by weight, and can be in one piece or several pieces together.
c) Covering the inner part(s): covering the inner part(s) with prepared outer part solution by mean of multiple depositing/filling processing method, rolling coating and/or dipping processing method, and/or dispersing & breaking processing method, so as to form a food with a structure of that the inner part(s) is/are fully covered by the outer part solution and trapped inside the prepared out part solution.
d) Freezing: set the foods, the outer part solution with inner part(s) trapped inside, to be fully frozen, and to reach the solid ice state under freezing condition of −20° C. to −60° C. The freezing time can be from 2 hours to 24 hours.
e) Lyophilization: Processing the frozen foods by lyophilization technology in a freeze-drying machine, including sublimation and drying processing steps, so as to obtain the lyophilized-food of the present invention, which is consists of two parts of outer part and inner part(s), and its inner part(s) is/are fixed in certain position inside the lyophilized-food and fully covered by the outer part of the lyophilized-food.

The outer part solution of the outer part of the present invention consists of aqueous phase food substances and materials and nonaqueous phase food substances and materials, there in the nonaqueous phase food substances and materials are in a ratio, by weight, of 0%-80%, preferably 10%-70% and more preferably 30%-50% of the outer part solution.

The aqueous phase food substances and materials of the outer part solution of the present invention are including drinking water either in still or in sparkling, or processed drinking water, fruit juice, vegetable juice, etc., and their mix in aqueous phase. There is no limitation on food materials used in the aqueous phase substance and materials of the outer part solution, which aqueous phase substance and materials of the outer part solution is in a water content of 30%-90%, preferably 50%-80% and without adding fat and oil.

The nonaqueous phase food substances and materials in the outer part solution the present invention are including, but not limited, at least one of substances and materials, including those from plants and/or from animals, of fat and oil, milk and milk products, fruits and vegetable, nuts, grains, starch and modified starch, sugar and sugar substitute and replacers, salt and spicy, food additives (including emulsifier, thickening agent, stabilizer, food flavors and colors, etc.), dietary fiber, nutrients and vitamins, edible mushrooms, probiotics and prebiotics, extractives and other plants materials including tea, flower, herbs and substance of the same family as food and medicine, and the processed one(s) or the mix by above substances.

The total fat content of the nonaqueous phase food substances and materials in the outer part solution of outer part is in a ratio of 0%-95%, preferably 30%-70% by weight of the nonaqueous phase food substances and materials.

The outer part of the lyophilized-food of the present invention is in a total fat content of 0%-45%, by weight of the outer part of the lyophilized-food.

The structure of the outer part of the lyophilized-food of the present disclosure is in a observed porous and/or microporous structure, if viewing it from within.

The inner part of the present invention is mainly consisting of, at least, at least, one of the following products made by food substances and materials:
a) which are in capsulation structure, and inside the capsule shell, the products is/are in continuous fat phase and/or in continuous water phase or continuous aqueous phase,
b) which are non-capsulated and in continuous fat phase,
c) which are in a structure of that a continuous water phase structure part enrobed or full covered by a layer in continuous fat phase structure,
d) which are the products of nuts, fruits and other food fully covered or enrobed by a continuous fat phase structure,
e) which are a mix from above.

The inner parts of the present invention can be either in regular or in non-regular shape, and they can be in individual particle(s) or mix and/or combination of several individual particles or pieces.

The inner parts of the present invention are in a size of 0.5 mm to 50 mm.

The inner part the present invention is in a ratio, by weight, of 20%-80%, preferably 40%-80% of the final finished lyophilized-food as in present invention.

The total fat content of the continuous fat phase product in the inner part of the lyophilized-food in the present invention is 27%-100%, preferably 30%-65% and more preferably 35%-55%.

The total water content of the continuous water phase product in the inner part of the lyophilized-food in the present invention is 20%-99%, preferably is 30%-90% and preferably 45%-90%.

The aroma and flavor of the individual piece(s) of the inner part of the present invention is/are not specific limited.

Comparing with other disclosed freeze-dried foods, including other disclosed freeze-dried chocolate, the lyophilized-food by this present invention has not only the properties of high thermal stability of no sticking on it packing, no melting and/or deforming under the temperature of 65° C., and the crispy or crunchy mouthfeel properties, the lyophilized-food by this present invention has also the following advantages of:
Provide consumer the watering and silky mouthfeel, and melt-in-mouth mouthfeel, similar to normal chocolate, which advantages are from its continuous fat/water phase inner part(s).
Except the inner part in continuous fat/water phase, other food inclusions such as nuts, fruits, vegetables, flowers & herbs, etc., either from plants or from animals, and their mix can also be mixed into the inner part which can provide consumer not only diversity on products structure but also more different mouthfeel, more rich and acceptable aroma and flavor enjoyment.

### BRIEF DESCRIPTION OF THE DRAWINGS

For better and clear description of the examples and technical method of the present invention, followings are the description of the attached photos or pictures. Obviously, the attached drawings described below are some embodiments of the present application. For those skilled in the art, other attached drawings can be obtained without making creative efforts based on these drawings.

FIGS. 1A-1C, are the appearance of the lyophilized-food products of the Example 1 of this present invention, therein, FIG. 1A is the top view of the products which means the outer part surface of the products in the bottom of the mould cavity, some black dots can be seen. FIG. 1B is the bottom of the products which means the top surface of the mould cavity. FIG. 1C is the section view of the product, there, the microporous structure of the outer part can be seen and chocolate drops are in the bottom of the mould cavity which means the top of the lyophilized-food product.

FIGS. 2A-2C, are the appearance of the lyophilized-food products of the Example 2 of this present invention, therein, FIG. 2A is the top view of the products which means the outer part surface of the products in the bottom of mould cavity, there is no any black dot can be seen. FIG. 2B is the bottom of the products which means the top surface of the mould cavity, there is no any black dot can be seen. FIG. 2C is the section view of the product, there, the microporous structure of the outer part can be seen, and there is a distinct boundary can be seen between the outer part solution of the first depositing and that of the second depositing and the chocolate drops are all supported and fixed in the middle position of the outer part of the lyophilized-food products by the first deposited and frozen outer part

### DETAILED DESCRIPTION OF THE EMBODIMENTS

The main objectives of the invention of the present disclosure is to provide a lyophilized-feed, including lyophilized-chocolate, and the processing method to produce it, to overcome the disadvantages from other disclosed freeze-dried products as mentioned above, to provide the watering, silky smooth and melt-in-mouth mouthfeel like eating normal chocolate, and, most important, at the mean while, also to maintain the same even higher thermal stability as Chinese patent No. CN202211705065.7 mentioned and claimed.

The present invention provides a lyophilized-food which product has a structure of: it consists of two parts of the outer part and the inner part, the two parts are all consist of food substance and materials and the products made from them. The inner part is/are in individual particles, in one pieces and/or several pieces together, fully covered and trapped by the outer part, and the inner part(s) is/are fixed inside the lyophilized-food by the outer part.

The present invention provides a lyophilized-food and the processing method to produce it, which processing method comprises following processing steps:
a) Making outer part solution: making the outer part solution of the outer part by the processing methods of dissolving, mixing, grinding, emulsifying and/or homogenizing. The outer part solution is in continuous-water phase or continuous aqueous phase, in paste state or in liquid state, with a total water content of 20% to 90%.
b) Preparing or making the inner part(s): preparing or making inner part(s) from food substance and material(s) according to the formulation of the lyophilized-food. The inner part is in a ratio of 20%-80% of the lyophilized-food, by weight, and can be in one piece or several pieces together.
c) Covering the inner part(s): covering the inner part(s) with prepared outer part solution by mean of multiple depositing/filling processing method, rolling coating and/or dipping processing method, and/or dispersing & breaking processing method, so as to form a food with a structure of that the inner part(s) is/are fully covered by the outer part solution and trapped inside the prepared out part solution.
d) Freezing: set the foods outer part solution with inner part(s) trapped inside to be fully frozen, to reach the solid ice state under freezing condition of −20° C. to −60° C. The freezing time can be from 2 hours to 24 hours.
e) Lyophilization: Processing the frozen foods by lyophilization technology in a freeze-drying machine, including sublimation and vacuum drying processing steps, so as to obtain the lyophilized-food which is consists of two parts of outer part and inner part(s), and its inner part(s) is/are fixed in certain position inside the lyophilized-food and fully covered by the outer part of the lyophilized-food.

The outer part solution of the outer part of the present invention consists of aqueous phase food substances and materials and nonaqueous phase food substances and materials, there in the nonaqueous phase food substances and materials are in a ratio, by weight, of 0%-80% of the outer part solution, preferably of 10%-70%, more preferably of 30%-50%.

The aqueous food phase substances and materials of the outer part solution of the present invention are including drinking water either in still or in sparkling, or processed drinking water, fruit juice, vegetable juice, etc., and their mix in aqueous phase. There is no limitation on food materials used in the aqueous phase substance and materials of the outer part solution, which aqueous phase substance and materials of the outer part solution is in a water content of 30%-100%, preferably of 50%-80%, and without adding fat and oil.

The nonaqueous phase food substances and materials in the outer part solution of the present invention are including at least one of substances and materials, including those from plants and/or from animals, of fat and oi, milk and milk products, fruits and vegetable, nuts, grains, starch and modified starch, sugar and sugar substitute and replacers, salt and spicy, food additives (including emulsifier, thickening agent, stabilizer, food flavors and colors, etc.), dietary fiber, nutrients and vitamins, edible mushrooms, probiotics and prebiotics, extractives and other plants materials including tea, flower, herbs and substance of the same family as food and medicine, and the processed one(s) or the mix by above substances.

The total fat content of the nonaqueous phase food substances and materials in the outer part solution of outer part is in a ratio of 0%-95%, preferably in a ratio of 30%-70% by weight of the nonaqueous phase food substances and materials.

The outer part of the lyophilized-food of the present invention is in a total fat content of 0%-35%, preferably of ≤30%, more preferably of ≤27%, by weight of the outer part of the lyophilized-food.

The structure of the outer part of the lyophilized-food of the present disclosure is in a observed porous and/or microporous structure.

The inner part of the present invention is mainly consists of, at least, one of the following products made by food substances and materials:
a) which are in capsulation structure, and inside the capsule shell, the products is/are in continuous fat phase and/or in continuous water phase or continuous aqueous phase,
b) which are non-capsulated and in continuous fat phase,
c) which are in a structure of that a continuous water phase structure inner part enrobed or full covered by a layer in continuous fat phase structure,
d) which are the products of nuts, fruits and other food fully covered or enrobed by a continuous fat phase structure,
e) which is a mix from above.

The inner parts of the present invention are in a size of 0.5 mm to 50 mm, preferably in a size of 1 mm to 10 mm, more preferably in a size of 3 mm to 8 mm.

The inner parts of the present invention can be either in regular or in non-regular shape, and they can be in individual particle(s) or mix and/or combination of several particles or pieces.

The inner part the present invention is in a ratio, by weight, of 20%-80% of the final finished lyophilized-food as in present invention, preferably in a ratio of 40%-80% by weight of the final finished lyophilized-food.

The total fat content of the continuous fat phase product in the inner part of the lyophilized-food in the present invention is 27%-100%, preferably 30%-65%, more preferably 35%-55%.

The total water content of the continuous water phase product in the inner part of the lyophilized-food in the present invention is 20%-99%, preferably 30%-90%, more preferably 45%-90%.

The aroma and flavor of the individual piece(s) of the inner part of the present invention is/are not specific limited.

To giving clear concept and definition of the product to be as the inner part of the lyophilized-food of the present invention, some products were listed here below as examples, but the following example products are not a limitation of the products selection of the inner part of the present invention:
a) Products in continuous fat phase: Chocolate drops and buttons made by chocolate dropping line or chocolate moulding line, which chocolate drops and buttons are in a total fat content from 27% to 45%, more preferably from 27% to 35%. Therein, the weight of the chocolate drops are from 0.02 g to 2 g, preferably from 0.05 g to 2 g, and the weight of the chocolate buttons are from 2.5 g to 15 g, preferably from 3 g to 6 g.
b) Products in continuous fat phase: Cold extruded or cold die-cast forming products in continuous fat phase, which are made from food materials mixed with edible fat or oil, through a processing of mixing, grinding or milling if necessary for reaching certain particle size, and then cold extruding or cold die-cast forming. The products are a in a total fat content from 23% to 65%, more preferably from 27% to 35%.
c) Capsulated products with liquid or paste in continuous fat phase or in continuous water phase inside, example the products so called popping boba beads, the total water content of the capsulated liquid or paste solution is in continuous water phase is from 30%-100%, and the total fat content of the liquid or paste in continuous fat phase is from 27%-100%.
d) The product with a combination of continuous water phase and continuous fat phase, for example, chocolate enrobed popping boba beads which is formed by the processing method of, by means of the enrobing or panning processing method, using continuous fat phase chocolate to completely cover the popping boba beads which are with a continuous water phase center, so as to form product with a structure of the a continuous water phase materials enrobed by a continuous fat phase materials.
e) The products panned or enrobed by a continuous fat phase outer layer, for example the nuts, the fruits and the pop-candies fully covered by chocolate by panning, enrobing and dipping, etc.

The multiple depositing/filling processing method as mentioned in the processing step c), Covering inner part of the present invention can, not limited, be processed in follow two methods:
a) Depositing the prepared out part solution of outer part to the cavities of the mold, to reach 5%-70% of the depth of the cavity, then adding prepared inner part pieces into the cavities till 30%-90% of the cavity depth reached, then filling the mold again with the prepared outer part solution to reach 99%-100% cavity depth of the mold, then send the mold to freezing processing step to set the solution with inner part inside to fully frozen or solid ice state by putting the mold under a freeze condition of −20° C. to −60° C.
b) Depositing the prepared outer part solution of outer part to the cavities of the mold, to reach 5%-70% of the depth of the cavity, then putting the mold under freezing condition of −5° C. to −60° C. for setting the solution being in partial frozen and/or fully frozen state. Removing the mold from freezing condition, adding prepared inner part to the cavities till 30%-90% of the cavity depth reached, then filling the mold again with the prepared outer part solution to 99%-100 cavity depth of the mold, then send the mold to freezing processing step to set the solution with inner part inside to fully frozen or solid ice state by putting the mold under a freeze condition of −20° C. to −60° C.

The rolling coating and/or dipping processing method, and/or dispersing & breaking processing method as mentioned in the processing step c), Covering inner part of the present invention can be, not limited, processed in follow three methods:
a) Covering each single piece of the prepared inner part(s) by rolling coating or panning method with the prepared outer part solution of the outer part, or by dipping the single piece of the inner part into the prepared outer part solution, then send them to freezing processing step to set them to be fully frozen or solid ice state under a freeze condition of −20° C. to −60° C.
b) Freezing the prepared inner part(s) under a freezing condition of −5° C. to −60° C. for from 2 hours to 24 hours, then covering the inner parts with the prepared outer part solution of the outer part by mean of enrobing, rolling coating or dipping, and then send coated goods to freezing processing step to set them to be fully frozen or solid ice state under a freeze condition of −20° C. to −60° C.
c) Dispersing the inner parts into the prepared outer part solution of the outer part of this present invention, in a pan or tray or suitable container, then freezing the outer part solution with inner part dispersed inside under the freeze condition of −10° C. to −60° C. for from 2 hours to 24 hours to form frozen foods to a fully frozen or solid ice state, and then breaking the frozen foods into pieces in 3-20 mm, then sending the frozen piece(s) to next processing step of lyophilization.

The lyophilization processing method as mentioned in the processing step e), the sublimation condition is: temperature is in 40° C.-70° C., vacuum is 5-50 Pa and sublimation time is 10-15 hours; the drying condition is: temperature 25° C.-30° C., vacuum 100-150 Pa and drying time is 10-15 hours, preferably the he sublimation condition is: temperature is in 40° C.-50° C., vacuum is 15-50 Pa and sublimation time is 10-15 hours; the drying condition is: temperature 25° C.-30° C., vacuum 100-150 Pa and drying time is 10-15 hours,

Comparing with other disclosed freeze-dried foods, including other disclosed freeze-dried chocolate, the lyophilized-food by this present invention has not only the properties of higher thermal stability of no sticking on it packing, no melting and/or deforming under the temperature of 70° C., and the crispy or crunchy mouthfeel properties, the lyophilized-food by this present invention has also the following advantages of:
a) Provide consumer the watering and silky mouthfeel, and melt-in-mouth mouthfeel, similar to normal chocolate, which advantages are from its continuous fat/water phase inner part(s).
b) Except the inner part in continuous fat/water phase, other food inclusions such as nuts, fruits, vegetables, flowers & herbs, etc., either from plants or from animals, and their mix can also be mixed into the inner part which can provide consumer not only diversity on products structure but also more different mouthfeel, more rich and multiple aroma and flavor enjoyment.

The technical solutions, the processing method and the testing result on appearance, sensory properties and thermal stability test of the lyophilized food and the processing method to make it of the present invention will be clearly and completely described below with reference to the examples of the present disclosure invention.

### Example 1

Lyophilized Fruits Tablet with Dark Chocolate Drops as Inner Part.

The formula of the outer part solution of outer part of this lyophilized-food is as follows (by weight): apple jams 50%, orange jams 10%, starch 5%, drinking water 35%.

The solid content of the apple jam used is 70%, the solid content of orange jam used is 60%.

The processing method of the Lyophilized fruits tablet included the following steps:
a) Making outer part solution: adding warm drink water, in around 35-45° C., into a mixer with high shear mixing head, then adding apple jam and orange jam step by step into the mixer while the mixer is running at 1000 rpm, finally adding starch into the mixer and keeping mixer running for round 15-30 minutes at 3000 rpm until well mixed that all jams and starch are all dissolved into water and the solution was fully emulsified.
b) Preparing inner part: preparing dark chocolate drops as the inner part, which chocolate drops are in total cocoa content of 65% and total fat content of 32% and in average weight of 0.05 g/piece from Giasiming (Zhuhai) Food Technology Co., Ltd.
c) Covering the inner parts: depositing the prepared outer part solution into the cavities of a mold, which cavities are all in a size of 20×20×15 (L×W×D in mm), till 40% of the cavity was filled, then adding dark chocolate drops into the cavities of the mold till 80% of cavity was reached (around 10 pieces of the chocolate drops added), then depositing the prepared outer part solution into the cavities of the mold until the cavities were full.
d) Freezing: Putting the mold into a freezer with setting temperature of −40° C. for 8-12 hours until being fully frozen, reaching solid ice state.
e) Lyophilization: putting the mold in a freeze-drying machine, setting the lyophilization processing steps as follows:
Sublimation: setting temperature at 50° C., vacuum in 15 Pa, sublimation time of 10 hours
Drying: setting temperature at 30° C., vacuum in 100 Pa, drying time of 13 hours Here, and in other examples of the present invention, the setting temperature under lyophilization processing steps mean setting the temperature of the heating plates of the freeze-drying machine.

After lyophilization finished, the lyophilized-food were obtained by demolding them from the mold, which finished products are in a water content of ≤4%.

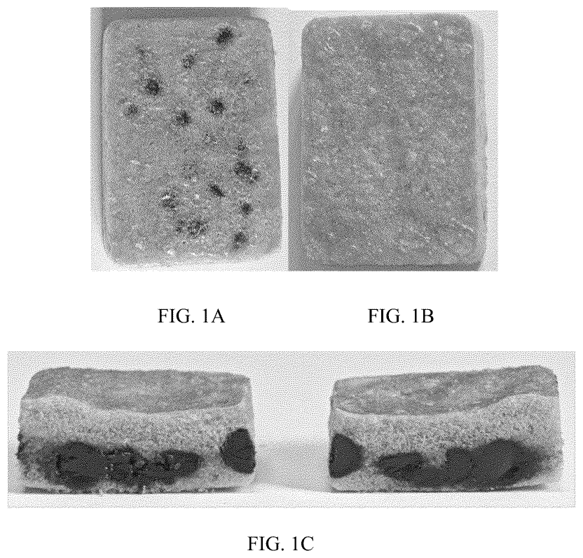

Appearance: As shown in FIGS. 1A-1C, from the top of the finished products, FIG. 1A, meaning bottom of the cavity of the mold, some black dots can be seen which are some chocolate drops going to near to the bottom of the cavities, but the chocolate drops are still inside the layer of the outer part. After cutting the products, as shown in FIG. 1C, the microporous can be seen in outer part, the chocolate drops are all near to the top of the products, meaning the bottom of the cavities, which is because the density, the weight of the chocolate drops, but the chocolate drops are still covered by a layer the outer part.

Sensory properties: the products is in crispy mouthfeel while biting it is with obviously identified mixed apple and orange flavor at the beginning, and then the chocolate melt with fat released from the chocolate drops bringing watering and silky smooth mouthfeel, and at the mean while, rich chocolate aroma and flavor coming out and mixed with the fruit flavor, and finally the chocolate aroma last in mouth for a long time.

Further explanation of the watering and silky smooth mouthfeel: the lyophilized fruit tablet in this example 1, it tastes more quick melt-in-mouth, more watering and silky smooth mouthfeel comparing with other freeze-dried food, including normal chocolate, because during sublimation of the lyophilization processing by the present disclosure, the crystallization structure of the well tempered chocolate drop was modified due to the sublimation temperature is higher than the melting point of the cocoa butter, the crystal structure of the cocoa butter was destroyed, which means the cocoa butter is not in stable crystallized state any more, the melting point of the cocoa butter in the chocolate drops were modified to a lower melting point, this enhances a melt-in-mouth mouthfeel, and because the higher fat content of the chocolate drops, fat content of 32%, provides the watering and silky smooth mouthfeel while the cocoa butter released from the chocolate drops.

Thermal stability test: after packing and sealing with aluminum foil, which aluminum foil is just to protect the product picking up moisture from surrounding, products were sent into a incubator with a setting temperature being adjusted to from 60° C. to 80° C. during the 4 hours testing time. After 4 hours testing time, no products deforming, sticking on packing and no fat releasing was found at temperature setting in 70° C., the products showed a better thermal stability.

| Temp (4 h) | 60° C. | 65° C. | 70° C. | 75° C. | 80° C. |
|---|---|---|---|---|---|
| Products deform | +++ | +++ | +++ | ++ | + |
| Sticking to packing | +++ | +++ | +++ | + | − |
| Fat release | +++ | +++ | +++ | + | − |

### Example 2

Lyophilized Fruits Tablet with Dark Chocolate Drops as Inner Part.

This example 2 is in a same formula as in Example 1, the differences are the processing steps and the appearance, from inside and outside of the finished products.

The formula of the outer part solution of outer part of this lyophilized-food is as follows (by weight): apple jams 50%, orange jams 10%, starch 5%, drinking water 35%.

The solid content of the apple jam used is 70%, the solid content of orange jam used is 60%.

The processing method of the lyophilized-food included the following steps:
a) Making outer part solution: adding warm drink water, in around 40-65° C., into a mixer with high shear head, then adding apple jam and orange jam step by step into the mixer while the mixer is running at 1000 rpm, finally adding starch into the mixer and keeping mixer running for round 15-30 minutes at 3000 rpm until well mixed that all jams and starch are all dissolved into water and the solution was fully emulsified.
b) Preparing inner part: preparing dark chocolate drops as the inner part, which chocolate drops are in total cocoa content of 65% and total fat content of 32% and in average weight of 0.05 g/piece from Giasiming (Zhuhai) Food Technology Co., Ltd.
c) Covering the inner parts: depositing the prepared outer part solution into the cavities of the mold, which cavities are all in a size of 20×20×15 (L×W×D), till 40% of cavity was filled. Differ to example 1 of adding dark chocolate drops directly after first depositing, the mold was sent to a freezer with a setting temperature of −40° C. for 2 hours for setting the first deposited outer part solution into partial or fully frozen state. After freezing, removing the mold from the freezer, then adding dark chocolate drops into the cavities of the mold till 80% of cavity was reached, then depositing the prepared outer part solution into the cavities of the mold until the cavities were full.
d) Freezing: putting the mold into a freezer with setting temperature of −40° C. for 6-8 hours until the goods in the cavities of the mold all reaching solid ice state.
e) Lyophilization: putting the mold in a freeze-drying machine, setting the lyophilization processing steps as follows
Sublimation: setting temperature at 50° C., vacuum in 15 Pa, sublimation time of 10 hours
Drying: setting temperature at 30° C., vacuum in 100 Pa, drying time of 13 hours

After lyophilization finished, the lyophilized-food were obtained by demolding them from the mold, which finished products are in a water content of ≤4%.

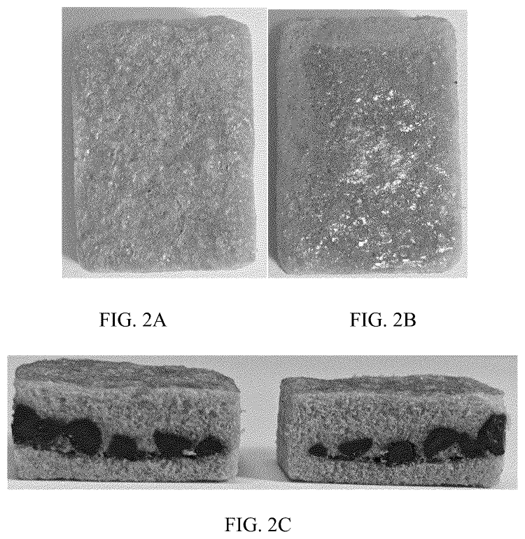

Appearance: as shown in FIGS. 2A-2C, no black dots can be seen neither from the top nor from the bottom of the products, as shown in FIG. 2A and FIG. 2B, which means the chocolate drops were fully supported by the frozen first deposited outer part solution. The better appearance obtained. After cutting the products, as shown in FIG. 2C, the microporous can be seen in fruits structure of the outer part and there is a distinct boundary between the outer part solution of the first depositing and that of the second depositing, and the chocolate drops are all supported and fixed, covered and trapped in the middle position by the outer part.

Sensory properties: no obvious difference comparing with Example 1. The products is in crispy mouthfeel while biting it with obviously identified mixed fruit aroma and flavor from the fruits of apple and orange, and then the chocolate melt by more biting and chewing with fat released from the chocolate bringing watering and silky smooth mouthfeel, and at the mean while, rich chocolate aroma and flavor coming out and mixed with the fruit flavor, and finally the chocolate aroma last in mouth for a long time.

Thermal stability test: after packing and sealing with aluminum foil, which aluminum foil is just to protect the products picking up moisture from surrounding during testing, products were sent into a incubator with a setting temperature being adjusted to from 60° C. to 80° C. during the 48 hours testing time. No products deforming, no sticking on packing and no fat releasing was found at 75° C. setting temperature after 48 hours testing time.

| Temp (48 h) | 60° C. | 65° C. | 70° C. | 75° C. | 80° C. |
|---|---|---|---|---|---|
| Products deform | +++ | +++ | +++ | +++ | ++ |
| Sticking to packing | +++ | +++ | +++ | +++ | + |
| Fat release | +++ | +++ | +++ | +++ | + |

### Example 3

Lyophilized Corn Tablet with Milk Chocolate Drops and Cheese Chunks as Inner Part.

The formula of the solution of outer food substance is as follows (by weight): ripe corn kernels 45%, starch 5%, drinking water 50%.

The processing method of the lyophilized-food included the following steps:
a) Making outer part corn solution: adding warm drink water, in around 40-65° C., into a mixer with high shear mixing head, then adding ripe corn kernels into the mixer while the mixer is running at 1000 rpm, after 20 minutes high share mixing, grinding the mix by sending the mix going through a colloid mill until the particle size of the mix reaching ≤55 microns, then reloading the ground corn liquid back to the mixer and adding starch into the mixer and keeping mixer running for round 15-30 minutes at 3000 rpm until well mixed and the corn solution was fully emulsified, the outer corn solution was obtained.
b) Preparing inner parts, for each cavity of the mold:
   Preparing 6-8 pieces of milk chocolate drops which in a total cocoa content of 35% and a total fat content of 35% and in average weight of 0.05 g/piece, which milk chocolate drops were from Giasiming (Zhuhai) Food Technology Co., Ltd.
   Preparing cheddar cheese as the inclusion of the inner part, which cheese is cheddar cheese from local supermarket, and cutting the cheese into around 3 mm square, taking 4-6 pieces of the cut cheese squares as inclusion.
c) Covering the inner part(s): depositing the prepared out part solution into the cavities of the mold, which cavities are all in a size of 25×30×15 mm (L×W×D), till 30% of cavity was filled, sent the mold into a freezer with a setting temperature of −40° C. for 2 hours for setting the first deposited outer part solution into partial or fully frozen state, after freezing, removing the mold from the freezer, then adding the milk chocolate drops and cheese squares into the cavities, then depositing the prepared solution into the cavities of the mold until the cavities were full.
d) Freezing: putting the mold into a freezer with setting temperature of −40° C. for 6-8 hours until all solution in the cavities of the mold were reaching a solid ice state.
e) Lyophilization: processing the frozen food by lyophilization technology. Putting the mold in a freeze-drying machine, setting the lyophilization processing steps as follows
Sublimation: setting temperature at 50° C., vacuum in 15 Pa, sublimation time of 10 hours
Drying: setting temperature at 30° C., vacuum in 100 Pa, drying time of 13 hours

After lyophilization finished, the lyophilized-food, the lyophilized corn tablets with milk chocolate drops and cheese squares inside were obtained by demolding them from the mold, which finished products are in a water content of ≤3%.

### Appearance:

The overall appearance of the products are in golden yellow color, no black dots can be seen neither from the top nor from the bottom of the products, which means the milk chocolate drops and cheese particles were fully supported and fixed inside the outer part by the frozen first deposited corn solution.

After cutting the products, the microporous can be seen in outer part structure of dried corn and the milk chocolate drops and cheese squares are covered and fixed in the middle position by the outer part, the lyophilized corn.

Sensory properties: the products is in more crispy and crunchy mouthfeel and with strong corn flavor at the beginning while biting it, and then the chocolate melt with fat released from the chocolate bringing watering and silky smooth mouthfeel with rich milky chocolate aroma, and at the mean while, little crispy mouthfeel and cheese aroma coming out from the cheese squares mixed with chocolate and corn flavor, the product provide a multiple mouthfeel of crunchy-watering/silky-crispy with silky, and finally the milky chocolate and cheese aroma last in mouth for a long time.

Thermal stability test: after packing and sealing with aluminum foil, products were sent into a incubator with a setting temperature being adjusted from 60° C. to 80° C. for 48 hours testing. After 48 testing hours, no products deforming, sticking on packing and fat releasing was found at the 75° C.

| Temp (48 h) | 60° C. | 65° C. | 70° C. | 75° C. | 80° C. |
|---|---|---|---|---|---|
| Products deform | +++ | +++ | +++ | +++ | ++ |
| Sticking to packing | +++ | +++ | +++ | +++ | + |
| Fat release | +++ | +++ | +++ | +++ | + |

### Example 4

Lyophilized-Chocolate in Button Like Shape with Chocolate Button as Inner Part.

The formula of the outer part solution of outer part of this lyophilized-chocolate is as follows (by weight): milk chocolate crumbs 50%, drinking water 45%, microcrystalline cellulose (MCC) 5%.

The milk chocolate crumbs are from Giasiming (Zhuhai) Food Technology Co., Ltd., with a total cocoa content of 35% and total fat content of 18%-20%, and without adding sugar.

The processing method of the lyophilized-food included the following steps:
a) Making outer part solution: adding warm drink water, in around 45-65° C., into a mixer with high shear head and a jacketed heating system, then adding milk chocolate crumbs step by step into the mixer while the mixer is running at 2000 rpm, finally adding microcrystalline cellulose into the mixer and keeping mixer running for round 30-40 minutes at 3000 rpm until getting the outer chocolate solution being well mixed and emulsified.
b) Preparing inner part: the inner part are dark chocolate buttons, made by Giasiming (Zhuhai) Food Technology Co., Ltd., with a 65% cocoa content and 32% total fat content, in a average weight of 3 g and a diameter of 10 mm. Putting the buttons in a −20° C. freezer for pre-cooling for 1-2 hours which pre-cooling is for better combination with the outer solution.
c) Covering the inner parts: filling the outer chocolate solution into the hopper of the enrober which is equipped with a horizontal agitator to the outer chocolate solution from delamination. Install the wire mesh belt and chocolate curtain parts, which curtain part is for forming chocolate curtain by chocolate solution from the hopper by a circulation pump. Take the pre-cooled chocolate button from freezer and put them onto the wire mesh belt, one by on in a distance of 20 mm. Start enrobing equipment to enrobe the dark chocolate button with the outer chocolate solution. The average thickness of the chocolate solution enrobed onto the dark chocolate button is 4-6 mm.
d) Freezing: a freezing tunnel with steel belt conveyor is connected to the enrober's wire mesh belt outlet, the milk chocolate solution enrobed dark chocolate button falling down to the steel belt of the freezing tunnel with a setting temperature of −50° C., and the freezing time is 1 hour which means the milk chocolate solution enrobed dark chocolate buttons is staying in the freezing tunnel for 1 hour. Colleting the enrobed buttons into a collecting tray white separating the buttons for avoiding stacking to each other, then put the tray(s) into a −20° C. refrigeration house for 12 hours until the outer milk chocolate solution being fully frozen to reach solid ice state.
e) Lyophilization: putting the tray(s) in a freeze-drying machine, setting the lyophilization processing steps as follows
Sublimation: setting temperature at 40° C., vacuum in 50 Pa, sublimation time of 10 hours
Drying: setting temperature at 25° C., vacuum in 150 Pa, drying time of 13 hours

After lyophilization finished, the lyophilized-milk chocolate with a dark chocolate button as its inner part were obtained, which finished products are in, the button like shape appearance, its water content of ≤4%.

### Appearance:

The products looks like a button shape, in a average diameter of 20 mm, with a well appearance.
After cutting the products, the microporous can be seen in the outer part milk chocolate, the inner part of the chocolate button being covered and trapped in the middle position by the outer part chocolate.

### Sensory Properties

The products is in crispy mouthfeel from the outer part chocolate with obviously identified milk chocolate flavor at first bite, then normal chocolate mouthfeel coming soon with continuous biting in, the dark chocolate button melts bringing the watering and silky smooth mouthfeel same as tasting a normal chocolate, and strong dark chocolate aroma and flavor released and last in mouth for a long time.

Thermal stability test: after packing and sealing with aluminum foil, which aluminum foil is just to protect the products picking up moisture from surrounding during testing, products were sent into a incubator with a setting temperature of from 60° C.-80° C. for 24 hours for higher thermal stability test. No products deforming, sticking on packing and fat releasing was found in 70° C. setting temperature after 24 hours testing.

| Temp (24 h) | 60° C. | 65° C. | 70° C. | 75° C. | 80° C. |
|---|---|---|---|---|---|
| Products deform | +++ | +++ | +++ | ++ | + |
| Sticking to packing | +++ | +++ | +++ | ++ | + |
| Fat release | +++ | +++ | +++ | ++ | + |

### Example 5

Lyophilized-Chocolate Tablet with Olive Oil Popping Boba Beads as Inner Part.

The lyophilized-chocolate product in this example 5 is with more watering mouthfeel than Example 4 and providing healthy olive oil to consumer during enjoying the chocolate.

The formula of the outer part solution of outer part of this lyophilized-food is as follows (by weight): dark chocolate crumbs 35%, drinking water 60%, microcrystalline cellulose (MCC) 5%.

The dark chocolate crumbs are from Giasiming (Zhuhai) Food Technology Co., Ltd., with a total cocoa content of 46% and total fat content of 18%-20%, and without adding sugar.

The processing method of the lyophilized-food included the following steps:
a) Making outer part solution: adding warm drink water, in around 40-65° C., into a mixer with high shear head, then adding dark chocolate crumbs step by step into the mixer while the mixer is running at 2000 rpm, finally adding microcrystalline cellulose into the mixer and keeping mixer running for round 30-40 minutes at 3000 rpm until well mixed that all jams and starch are all dissolved into water and the solution was fully emulsified.
b) Preparing inner part:
   Take 8-10 pieces olive oil popping boba beads as the inner part for each cavity of the mold.
   Which popping boba beads are, made by Qingdao Bright Moon Group, in around 3 mm in diameter with 100% olive oil inside the shell. The popping boba beads were made by olive oil capsulated inside shell from sodium alga acid+gum, then firmed the dry shell by low temperature heating.
c) Covering the inner parts: depositing the prepared outer part solution into the cavities of the mold, which cavities are all in a size of 27×27×15 (L×W×D), till 40% of cavity was filled. Send the mold to a freezer with a setting temperature of −50° C. for 2 hours for setting the first deposited outer part solution into partial or fully frozen state. After freezing, removing the mold from the freezer, then adding the prepared popping boba beads into the cavities of the mold, then depositing the prepared outer part solution into the cavities of the mold until the cavities were full.
d) Freezing: putting the mold into a freezer with setting temperature of −50° C. for 1 hour and then putting the mold in −20° C. temperature condition for 12 hours until the goods in the cavities of the mold all fully frozen and reaching solid ice state.
e) Lyophilization: putting the mold in a freeze-drying machine, setting the lyophilization processing steps as follows
Sublimation: setting temperature at 40° C., vacuum in 50 Pa, sublimation time of 10 hours
Drying: setting temperature at 25° C., vacuum in 150 Pa, drying time of 13 hours

After lyophilization finished, the lyophilized-chocolate were obtained by demolding them from the mold, which finished products are in a water content of ≤4%.

### Appearance:

No any dots can be seen neither from the top nor from the bottom of the products, which means the olive oil popping boba beads were fully supported by the frozen first deposited outer part solution.
After cutting the products, the microporous can be seen in the outer part chocolate and the inner parts of popping boba beads were covered and trapped in the middle position by the outer part chocolate.

### Sensory Properties:

The products is in crispy mouthfeel from the outer part chocolate with obviously identified chocolate flavor at first bite, then
With continuous biting in, popping boba beads were broken, the olive oil released from the broken popping boba beads providing more watering/oiling and silky smooth mouthfeel, and enhancing the chocolate aroma. Except cocoa butter, this products provide more healthy compound from released olive oil to consumer.

Thermal stability test: after packing and sealing with aluminum foil, which aluminum foil is just to protect the products picking up moisture from surrounding during testing, products were sent into a incubator with a setting temperature of from 60° C. to 80° C. for 24 hours testing time. No products deforming, sticking on packing and fat releasing was found at the setting temperature of 70° C. after 24 hours testing.

| Temp (24 h) | 60° C. | 65° C. | 70° C. | 75° C. | 80° C. |
|---|---|---|---|---|---|
| Products deform | +++ | +++ | +++ | ++ | + |
| Sticking to packing | +++ | +++ | +++ | ++ | + |
| Fat release | +++ | +++ | +++ | ++ | − |

### Example 6

Lyophilized Cheese Chocolate Tablet with Rose Flavor White Chocolate Drops as Inner Part (Lyophilized Rose-Cheese Chocolate)

The formula of the outer part solution of outer part of this lyophilized-food is as follows (by weight): milk chocolate 20%, cheddar cheese powder 8%, drinking water 70%, microcrystalline cellulose (MCC) 2%.

The milk chocolate are from local supermarket, with a total cocoa content of 29% and total fat content of 40%, and the cheddar cheese powder from is local food material market.

The processing method of the lyophilized-food included the following steps:
a) Making outer part solution:
   Melting the milk chocolate in a double jacket melter with a setting temperature of 55-65° C., stirring the chocolate timely during melting until the chocolate completely melt.
   Adding warm drink water, in around 45-50° C., into a mixer with high shear head, which mixer is with double jacket heating function and being set at 50° C., then adding melted chocolate step by step into the mixer while the mixer is running at 2000 rpm until all chocolate of the formula were added and completely dispersed into the warm water, getting the chocolate solution.
   Processing the chocolate solution for homogenization through a homogenizer with a setting pressure of 18 MPa, to break the fat particles in the chocolate to be as small as possible, the purposes of this homogenization processing are:
      for the chocolate can be fully and evenly dissolved and dispersed into the water phase.
      for avoiding the fat accumulation which will cause harder mouthfeel and low down thermal stability.
   Filling the homogenized chocolate solution into the mixer, adding cheese powder and the microcrystalline cellulose into the chocolate solution in the mixer and keeping mixer running for round 30-40 minutes at 3000 rpm until well mixed and fully emulsified, the cheese flavor outer chocolate solution is obtained.
b) Preparing inner part:
   Purchasing rose flavor white chocolate from local supermarket which chocolate tablets are in a total fat content of 35% and with added rose flower flakes.
   Preparing 6-7 pieces of rose flavor white chocolate chunks as the inner part for each cavity of the mold by cutting the rose flavor white chocolate tablets into 5×5 mm chunks.
c) Covering the inner parts:
   Depositing the prepared outer part solution into the cavities of the mold, which cavities are in round shape with a diameter of 30 mm and a depth of 18 mm, till 40% of cavity was filled.
   Send the mold to a freezer with a setting temperature of −50° C. for 2 hours for setting the first deposited outer part solution into partial or fully frozen state.
   After freezing, removing the mold from the freezer, then adding prepared rose flavor white chocolate chunks into the cavities of the mold.
   Depositing the prepared outer part solution into the cavities of the mold until the cavities were full.
d) Freezing:
   Putting the mold into a freezer with setting temperature of −50° C. for 1 hours as pre-freezing
   Removing the mold into another freezer with a setting temperature of −50° C. for 12 hours deep freezing until the outer part solution in the cavities of the mold all reaching solid ice state.
e) Lyophilization: putting the mold in a freeze-drying machine, setting the lyophilization processing steps as follows
Sublimation: setting temperature at 50° C., vacuum in 50 Pa, sublimation time of 10 hours
Drying: setting temperature at 25° C., vacuum in 150 Pa, drying time of 13 hours

After lyophilization finished, the lyophilized Rose-Cheese chocolate were obtained by demolding them from the mold, which finished products are in a water content of ≤4%.

### Appearance:

No white dots can be seen neither from the top nor from the bottom of the products, products are in a well light brown color and no damage on surface and corner.
After cutting, it can be observed clearly the microporous structure from the outer part of the product, and the white chocolate chunks were fully covered and rapped inside the outer part chocolate, and also the white chocolate chunks are still in white.

### Sensory Properties

The products is in crispy mouthfeel from the outer part chocolate with obviously identified cheese and milk chocolate flavor at first bite, then.
With continuous biting, the chocolate chunks melt completely with fat released from the chunks, which bringing not only watering and silky smooth mouthfeel, but also strong rose and milky aroma and flavor, and the multiple aroma remained for a long time after eating.

Thermal stability test: after packing and sealing with aluminum foil, which aluminum foil is just to protect the products picking up moisture from surrounding during testing, products were sent into a incubator with a setting temperature of from 60° C. to 80° C., the testing time is 24 hours. No products deforming, sticking on packing and fat releasing was found at 70° C. setting temperature condition after 24 hours testing.

| Temp (24 h) | 60° C. | 65° C. | 70° C. | 75° C. | 80° C. |
|---|---|---|---|---|---|
| Products deform | +++ | +++ | +++ | ++ | + |
| Sticking to packing | +++ | +++ | +++ | ++ | + |
| Fat release | +++ | +++ | +++ | + | − |

Finally, it should be noted that: the above examples are used to explain the technical solution method of the present disclosure invention in detail, they are not the limitation of the present disclosure invention. However, ordinary technicians in this field should understand: the examples can still modify the technical solutions recorded in the aforementioned embodiments, or make equivalent substitutions for some or all of the technical features therein, and these modifications or substitutions do not deviate the essence of the corresponding technical solutions from the scope of the technical solutions of each embodiment of the present application, and all of these modifications or substitutions shall fall within the protection scope of the present disclosure invention.

1. A lyophilized-food, comprising two parts of outer part and inner part, the two parts are consist of food substance and materials and products made from them; the inner part is in individual particles, in one piece and/or several pieces together, fully covered and trapped by the outer part, and the inner part is fixed inside the lyophilized-food by the outer part.

2. A processing method to produce the lyophilized-food according to claim 1, comprising following processing steps:
a) making outer part solution: making the outer part solution of the outer part by processing methods of dissolving, mixing, grinding, emulsifying and/or homogenizing; the outer part solution is in continuous-water phase or continuous aqueous phase, in paste state or in liquid state, with a total water content of 20% to 90%;
b) preparing or making the inner part: preparing or making the inner part from food substance and material according to formulation of the lyophilized-food; the inner part is in a ratio of 20%-80% of the lyophilized-food, by weight, and is allowed to be in one piece or several pieces together;
c) covering the inner part: covering the inner part with prepared outer part solution by mean of multiple depositing/filling processing method, rolling coating and/or dipping processing method, and/or dispersing & breaking processing method, to form a foods with a structure of that the inner part is fully covered by the outer part solution and trapped inside the prepared outer part solution;
d) freezing: setting foods outer part solution with inner part trapped inside to be fully frozen, to reach a solid ice state under freezing condition of −20° C. to −60° C.; freezing time is allowed to be from 2 hours to 24 hours;
e) lyophilization: processing frozen foods by lyophilization technology in a freeze-drying machine, comprising sublimation and drying processing steps, to obtain the lyophilized-food consisting of the two parts of outer part and inner part, and the inner part is fixed in predetermined position inside the lyophilized-food and fully covered by the outer part of the lyophilized-food.

3. The processing method according to claim 2, wherein the outer part solution of the outer part consists of aqueous phase food substances and materials and nonaqueous phase food substances and materials, wherein the nonaqueous phase food substances and materials are in a ratio, by weight, of 0%-80% of the outer part solution.

4. The processing method according to claim 3, wherein the aqueous phase food substances and materials of the outer part solution are comprising drinking water either in still or in sparkling, or processed drinking water, fruit juice, vegetable juice, and their mix in aqueous phase; there is no limitation on food materials configured in aqueous phase substance and materials of the outer part solution, wherein the aqueous phase substance and materials of the outer part solution is in a water content of 30%-100%, and without adding fat and oil.

5. The processing method according to claim 3, wherein the nonaqueous phase food substances and materials in the outer part solution are comprising at least one of substances and materials, comprising those from plants and/or from animals, of fat and oi, milk and milk products, fruits and vegetable, nuts, grains, starch and modified starch, sugar and sugar substitute and replacers, salt and spicy, food additives, dietary fiber, nutrients and vitamins, edible mushrooms, probiotics and prebiotics, extractives and other plants materials comprising tea, flower, herbs and substance of the same family as food and medicine, and processed one or mix by above substances; a total fat content of the nonaqueous phase food substances and materials in the outer part solution is in a ratio of 0%-95% by weight, wherein the food additives comprises emulsifier, thickening agent, stabilizer, food flavors and colors.

6. The processing method according to claim 2, wherein the inner part is an individual piece or particle or a mix or combination of several individual pieces, with a particle size of 0.5 mm to 50 mm, in regular or non-regular shape, and is totally in a ratio of 20%-80% of a total weight of the lyophilized-food; the inner part is consisting of, at least, one of the following products made by food substances and materials:
a) being in capsulation structure, and inside a capsule shell, the products are in continuous fat phase and/or in continuous water phase or continuous aqueous phase,
b) being non-capsulated and in continuous fat phase,
c) being in a structure of that a continuous water phase structure part enrobed or full covered by a layer in continuous fat phase structure food substances,
d) being the products of nuts, fruits and other food fully covered or enrobed by a continuous fat phase structure,
e) being a mix from above.

7. The processing method according to claim 6, wherein a total fat content of a continuous fat phase individual piece of the inner part is 27%-100%, and a total water content of a continuous water phase individual piece of the inner part is 20%-99%; aroma and flavor of the individual piece, comprising continuous fat phase and water phase, of the inner part is not specific limited.

8. The processing method according to claim 2, wherein
multiple depositing/filling processing method of covering inner part processing step comprise, not limited, following two processing ways:
a) depositing the prepared outer part solution of outer part to cavities of mold, to reach 5%-70% of a depth of the cavity, adding prepared inner part pieces into the cavities till 30%-90% of the cavity depth reached, filling the mold again with the prepared outer part solution to reach 99%-100% cavity depth of the mold, sending the mold to freezing processing step to set the solution with inner part inside to fully frozen or solid ice state by putting the mold under a freeze condition of −20° C. to −60° C.;
b) depositing the prepared outer part solution of outer part to the cavities of the mold, to reach 5%-70% of the depth of the cavity, putting the mold under freezing condition of −5° C. to −60° C. for setting the solution being in partial frozen and/or fully frozen state; removing the mold from freezing condition, adding prepared inner part to the cavities till 30%-90% of the cavity depth reached, filling the mold again with the prepared outer part solution to 99%-100 cavity depth of the mold, sending the mold to freezing processing step to set the solution with inner part inside to fully frozen or solid ice state by putting the mold under a freeze condition of −20° C. to −60° C.;
rolling coating and dipping processing method of the covering inner part processing step is allowed to be processed in following three methods:
a) covering each single piece of the prepared inner part by rolling coating or panning method with the prepared outer part solution of the outer part, or by dipping the single piece of the inner part into the prepared outer part solution, sending them to freezing processing step to set them to be fully frozen or solid ice state under a freeze condition of −20° C. to −60° C.;
b) freezing the prepared inner part under a freezing condition of −5° C. to −60° C. for from 2 hours to 24 hours, covering the inner parts with the prepared outer part solution of the outer part by mean of enrobing, rolling coating or dipping, and sending coated goods to freezing processing step to set them to be fully frozen or solid ice state under a freeze condition of −20° C. to −60° C.;
dispersing & breaking method of the covering inner part processing step is allowed to be processed in following three methods:
a) dispersing the inner parts into the prepared outer part solution of the outer part, in a pan or tray or suitable container, freezing the outer part solution with inner part dispersed inside under a freeze condition of −10° C. to −60° C. for from 2 hours to 24 hours to form frozen foods to a fully frozen or solid ice state, and breaking the frozen foods into pieces in 3-20 mm, sending a frozen piece to next processing step of lyophilization.

9. The processing method according to claim 2, wherein in lyophilization processing, a sublimation condition is: temperature is in 40° C.-70° C., vacuum is 5-50 Pa and sublimation time is 10-15 hours; a drying condition is: temperature 25° C.-30° C., vacuum 100-150 Pa and drying time is 10-15 hours.

10. The processing method according to claim 2, wherein except the inner part in continuous fat/water phase, other food inclusions such as nuts, fruits, vegetables, flowers & herbs, either from plants or from animals, and their mix is further allowed to be mixed into the inner part as inclusions.

11. The processing method according to claim 2, wherein the outer part solution of the outer part consists of aqueous phase food substances and materials and nonaqueous phase food substances and materials, wherein the nonaqueous phase food substances and materials are in a ratio, by weight, of 10%-70% of the outer part solution.

12. The processing method according to claim 2, wherein the outer part solution of the outer part consists of aqueous phase food substances and materials and nonaqueous phase food substances and materials, wherein the nonaqueous phase food substances and materials are in a ratio, by weight, of 30%-50% of the outer part solution.

13. The processing method according to claim 3, wherein the aqueous phase food substances and materials of the outer part solution are comprising drinking water either in still or in sparkling, or processed drinking water, fruit juice, vegetable juice, and their mix in aqueous phase; there is no limitation on food materials configured in aqueous phase substance and materials of the outer part solution, wherein the aqueous phase substance and materials of the outer part solution is in a water content of 50%-80%, and without adding fat and oil.

14. The processing method according to claim 3, wherein the nonaqueous phase food substances and materials in the outer part solution are comprising at least one of substances and materials, comprising those from plants and/or from animals, of fat and oi, milk and milk products, fruits and vegetable, nuts, grains, starch and modified starch, sugar and sugar substitute and replacers, salt and spicy, food additives, dietary fiber, nutrients and vitamins, edible mushrooms, probiotics and prebiotics, extractives and other plants materials comprising tea, flower, herbs and substance of the same family as food and medicine, and processed one or mix by above substances; a total fat content of the nonaqueous phase food substances and materials in the outer part solution is in a ratio of 30%-70% by weight, wherein the food additives comprises emulsifier, thickening agent, stabilizer, food flavors and colors.

15. The processing method according to claim 2, wherein the inner part is an individual piece or particle or a mix or combination of several individual pieces, with a particle size of 0.5 mm to 50 mm, in regular or non-regular shape, and is totally in a ratio of 40%-80% of a total weight of the lyophilized-food; the inner part is consisting of, at least, one of the following products made by food substances and materials:
a) being in capsulation structure, and inside a capsule shell, the products are in continuous fat phase and/or in continuous water phase or continuous aqueous phase,
b) being non-capsulated and in continuous fat phase,
c) being in a structure of that a continuous water phase structure part enrobed or full covered by a layer in continuous fat phase structure food substances,
d) being the products of nuts, fruits and other food fully covered or enrobed by a continuous fat phase structure,
e) being a mix from above.

16. The processing method according to claim 6, wherein a total fat content of a continuous fat phase individual piece of the inner part is 27%-100%, and a total water content of a continuous water phase individual piece of the inner part is 30%-90%; aroma and flavor of the individual piece, comprising continuous fat phase and water phase, of the inner part is not specific limited.

17. The processing method according to claim 6, wherein a total fat content of a continuous fat phase individual piece of the inner part is 27%-100%, and a total water content of a continuous water phase individual piece of the inner part is 45%-90%; aroma and flavor of the individual piece, comprising continuous fat phase and water phase, of the inner part is not specific limited.

18. The processing method according to claim 6, wherein a total fat content of a continuous fat phase individual piece of the inner part is 30%-65%, and a total water content of a continuous water phase individual piece of the inner part is 20%-99%; aroma and flavor of the individual piece, comprising continuous fat phase and water phase, of the inner part is not specific limited.

19. The processing method according to claim 6, wherein a total fat content of a continuous fat phase individual piece of the inner part is 35%-55%, and a total water content of a continuous water phase individual piece of the inner part is 20%-99%; aroma and flavor of the individual piece, comprising continuous fat phase and water phase, of the inner part is not specific limited.

20. The processing method according to claim 2, wherein in lyophilization processing, a sublimation condition is: temperature is 40° C.-50° C., vacuum is 15-50 Pa and sublimation time is 10-15 hours; a drying condition is: temperature 25° C.-30° C., vacuum 100-150 Pa and drying time is 10-15 hours.
